(19) United States
(12) Patent Application Publication
(10) Pub. No.: US 2007/0042658 A1
(43) Pub. Date: Feb. 22, 2007

(54) FIBER-CONTAINING ARTICLE AND METHOD OF MANUFACTURE

(75) Inventors: Anthony Joseph Cline, Letts, IA (US); Steven S. Deaton, Muscatine, IA (US); Steven P. Lee, Muscatine, IA (US); Rusty W. Morehead, Illinois City, IL (US); Rodney P. Thulen, Muscatine, IA (US); YingYing Zhou, Coralville, IA (US)

Correspondence Address: FAEGRE & BENSON, LLP;PATENT DOCKETING, 90 SOUTH SEVENTH STREET, 2200 WELLS FARGO CENTER, MINNEAPOLIS, MN, 55402, US

(73) Assignee: HNI Technologies Inc., Muscatine, IA (US)

(21) Appl. No.: 11/470,799

(22) Filed: Sep. 7, 2006

Related U.S. Application Data
(63) Continuation-in-part of application No. 11/421,328, filed on May 31, 2006.
Application No. 11/421,328 is a continuation-in-part of application No. 11/058,462, filed on Feb. 14, 2005, now abandoned.

(51) Int. Cl. B32B 27/12; B29C 59/00; D04H 1/20

(52) U.S. Cl. 442/136; 264/112; 264/129; 427/393.3

(57) ABSTRACT

A fire resistant or acoustical article comprising a bast fiber component, a thermoplastic material that acts as a binder, and a first fire retardant component, the article having a coating of a second fire retardant component, such that the article may be used in the manufacture of structures having a Class A fire rating. According to one method of manufacture, a fibrous mass including a bast fiber component and a thermoplastic binder is heated and compressed to a desired thickness and density, followed by the dispersal of the first fire retardant there through, and coated with the second fire retardant component.

### CROSS-REFERENCE TO RELATED APPLICATION

This application is a continuation-in-part of U.S. application Ser. No. 11/421,328 filed on May 31, 2006 which is a continuation-in-part of U.S. application Ser. No. 11/058,462, filed Feb. 14, 2005, entitled “Fire-Resistant Fiber-Containing Article and Method of Manufacture,” the entire disclosure of each application is incorporated by reference herein.

### TECHNICAL FIELD

This invention relates to a fire-resistant and/or acoustical absorbing article comprising a portion of natural fibers. More particularly, this invention relates to a fire-resistant and/or acoustical absorbing article having a portion of natural fibers and being suitable for use in the manufacture of fire-retardant and/or acoustical absorbing structures, and to a method of manufacturing such an article.

### BACKGROUND

Fiberglass is well known for use as a component of office furniture, office partitions, and other structures used in office, school, commercial, and industrial settings.

Fiberglass has many advantages for such applications. It is relatively inexpensive, it can be worked into a variety of shapes and densities, and it has good fire-resistance properties.

Recently, however, concerns have been raised about such ubiquitous uses of fiberglass. Some have expressed concerns about health or safety risks that might occur during the use or manufacture of fiberglass articles. Concerns also have been raised about the use of certain volatile organic compounds and adhesive systems, such as aldehyde compounds and formaldehyde in particular, that are typically involved in fiberglass-containing structures. Thus there has been increased customer interest in office furniture and other office products that do not include fiberglass as a component.

Agricultural fibers are gaining interest as a natural, renewable resource with potential for use in a variety of manufactured products. In particular, bast fibers such as industrial hemp, kenaf, jute, sisal and flax can be made into non-woven sheet-like products in roll form that can then be used in subsequent manufacturing processes. In some situations, bast fiber products are preferred as natural products that do not harm the environment and that do require the use of volatile organic compounds. It is known to manufacture articles using bast fibers and a thermoplastic binder, as disclosed for example, in U.S. Pat. No. 5,709,925, which discloses the use of such a composition for an interior trim panel for a motor vehicle.

For furniture and other structures intended for use in an office environment it is desirable to have a Class A fire resistance rating. This means that such products have a flame spread index of 25 or less, and a smoke generation index of 450 or less, as measured by the test procedures set forth in ASTM E 84 and UL 723. Agricultural fibers however are inherently flammable. Thus, when such agricultural fiber products are used in an office environment, the products typically include some treatment to provide for adequate flame resistance or to meet Class A requirements.

One such effort to make a fire-resistant article with natural fibers is described in U.S. Patent Application Publication No. US 2004/0028958 A1, wherein a moldable batt comprises a fire-retardant cellulose, a fiber component, and a binder component, the batt being compressed and heated to form fire-resistant panels or other products that are said to be particularly useful in the office furniture industry.

### SUMMARY OF THE INVENTION

It is thus one objective of the invention to provide an article that can be used in the manufacture of office furniture, partitions, and other structures, which article does not include fiberglass.

It is thus another objective of the invention to provide an article that can be used in the manufacture of office furniture, partitions, and other structures, which article includes bast fibers as a component thereof yet which meets the standards for a Class A fire resistance rating and which has desirable acoustical absorbing properties.

In accordance with the invention, a fire-resistant article comprises a fibrous mass having both a natural fiber component and a thermoplastic binder and about 5-40 wt. % (based on the weight of the fibrous mass) of a first fire retardant component mixed therein. The fibrous mass comprises about 1-50 wt. % thermoplastic binder and about 50-99 wt. % natural fiber. In addition, the fibrous mass has a coating of a second fire retardant component of about 1-30 wt. % on the exterior surfaces thereof. By appropriate selection of the natural fibers, the thermoplastic binder, and the first and second fire retardant components, it is possible to make an article having both flame spread index values and smoke generation index values that fall within the Class A fire rating. Moreover, the article is made free of fiberglass and free of the formaldehyde commonly used with fiberglass.

In one embodiment, the fiber mass comprises about 10-50 wt. % thermoplastic binder and about 50-90 wt. % natural fiber and in other embodiments comprises about 10-30 wt. % thermoplastic binder and 70-90 wt. % natural fiber. In another embodiment, the fiber mass comprises about 5-40 wt. % of the first fire retardant component and in other embodiments comprises about 5-15 wt. % of the first fire retardant component.

The natural fiber content of the fiber component may be made up of a variety of bast fibers, including fibers such as kenaf, jute, industrial hemp, sisal, flax, and mixtures thereof. In some embodiments a mixture of kenaf and industrial hemp is used. In other embodiments, kenaf alone is used. Natural fibers are a renewable resource, and one which does not emit potentially hazardous materials into the environment. The thermoplastic material or binder is mixed with the natural fiber in sufficient quantity to bind the fibers together upon the application of heat. Suitable thermoplastic binders or materials include polypropylene, polyethylene, polyesters, nylon, copolymers, and mixtures thereof. The thermoplastic materials may be in the form of fibers, bi-component fibers, powders, or pellets.

One embodiment of the inventive method of making a fire-resistant article comprises the steps of providing a fibrous mass comprising a mixture of thermoplastic material and natural fibers, dispersing a first fire retardant component in the fibrous mass, compressing and heating the fibrous mass to form a shaped article, and applying a coating of a second fire retardant component to the shaped article. The first fire retardant component may be in a powder form that is either blown through the fibrous mass or drawn through under reduced pressure. After the first fire retardant is dispersed through the fibrous mass, the mass is heated to a temperature above the softening temperature of the thermoplastic material but below the temperature where undesired thermal degradation of the natural fibers occurs, and is then compressed. Suitable compression apparatus include, for example, platens, nip rollers, or flat bed laminators. The second fire retardant may be applied to the outer surfaces of the compressed mass such as in a solution or liquid medium. In one embodiment of the method, the article may be heated again to drive off any water used in the solution or liquid medium.

Another embodiment of the inventive method of making a fire-resistant article comprises the steps of providing a fibrous mass comprising a mixture of thermoplastic material and natural fibers, compressing and heating the fibrous mass to form a shaped article, and then dispersing a first fire retardant component into the shaped article. A second fire retardant component can be applied on the shaped article after the dispersal of the first fire retardant component into the shaped article. The first fire retardant component may be in a powder form that is either blown through the fibrous mass, drawn through under reduced pressure, or scattered on the surface of the fibrous mass. Alternatively, the first fire retardant component may be applied in a solution or other liquid form. The second fire retardant may be applied to the outer surfaces of the shaped article such as in a powder, solution, foamed or liquid form. In one embodiment of the method, the article may be heated again to drive off any water used in the solution or liquid medium.

In an alternative method, the first flame retardant component may be dispersed through the fibrous mass, the second flame retardant component can be applied to the outer surfaces of the fibrous mass, and the mass can be compressed with heat to soften the thermoplastic materials, to bind the natural fibers, and to drive off any water used in the solution or liquid medium from the application of the second flame retardant component.

Through appropriate choices of materials and processing conditions, the resulting article can be made to have a flame spread index and smoke generation index low enough to meet a Class A fire rating, as well as having desirable acoustical properties. An article can be designated as having a Class A fire rating if the flame spread index (FSI) is less than 25 and the smoke generation index is 450 or less. Additionally, the article is considered to have desirable acoustical properties if a suitable structure made of the article, such as office partition panels for example, has a sound transmission class (STC) above 15 and/or a noise reduction coefficient above 0.5 The article can be used in the manufacture of office dividers or partition panels, ceiling tiles bulletin boards, and other structures requiring a Class A fire rating that are used in office, school, commercial and industrial settings.

### DESCRIPTION OF THE DRAWINGS

The present invention can be more readily understood by reference to the following drawings.

FIG. 1 is a schematic drawing of a method of making a fire-resistant article of the present invention.

FIG. 2 is a schematic drawing of an alternative method of making a fire-resistant article of the present invention.

FIG. 3 is a schematic drawing of another alternative method of making a fire-resistant article of the present invention.

FIG. 4 is a schematic drawing of a further alternative method of making a fire-resistant article of the present invention.

FIG. 5 is a schematic drawing of yet another alternative method of making a fire-resistant article of the present invention.

### DETAILED DESCRIPTION OF THE INVENTION

A fire-resistant article of the present invention comprises a fibrous mass having a fiber component and about 5-40 wt. % of a first fire retardant component mixed therein; the fiber component comprising about 1-50 wt. % thermoplastic and about 50-99 wt. % natural fiber, the fibrous mass having a coating of a second fire retardant component of about 1-30 wt. % on the exterior surfaces thereof. Additionally, the fire-resistant article has a Class A fire rating and desirable acoustical properties.

The fibrous mass used in the manufacture of the fire-resistant article can be provided in the form of long sheets shipped as rolls. Such rolls may be commercially fabricated to include natural fibers and thermoplastic materials to a purchaser's specifications.

The natural fiber component of the fibrous mass is derived from the family of bast fiber plants in which a plant stalk has bast fibers and a core. The preferred bast fiber plants will be those in which the bast fibers are readily separated from the core of the stalk. Particularly suitable bast fiber plants for this purpose include kenaf, jute, industrial hemp, sisal, and flax. Any of these plant materials may be used alone or in combination with each other, and in various proportions. The selection of the plant materials to be used will be based on ease of manufacture into the fibrous mass for use in the invention, cost, availability, and fire resistance in the finished article based on empirical tests. In one embodiment, a mixture of kenaf and industrial hemp is used. In another embodiment, only kenaf is used. Further, while various proportions of the different fibers can be used, a fibrous mass in which the natural fiber component comprises kenaf and industrial hemp fibers in about equal proportions by weight is used.

The thermoplastic material or component should have a softening temperature below a temperature that would cause undesired thermal degradation of the natural fibers. Suitable thermoplastic components can be selected from the group consisting of polypropylene, polyethylene, polyesters, nylon, copolymers, and mixtures thereof. Of these, polypropylene is suitable because of its ready availability and its low cost. The thermoplastic component in the form of fibers may be readily incorporated in the fibrous mass in the initial manufacture thereof. In one embodiment, the fibers may include bi-component fibers, in which fibers of a first thermoplastic material are coated or encased within a second thermoplastic material having a lower softening temperature. Alternatively, the thermoplastic component may be in other forms such as powders or pellets that can be readily incorporated in the fibrous mass.

Because of the inherent flammability of both the natural fibers and the thermoplastic materials used in the fibrous mass, a first fire retardant is dispersed throughout the fibrous mass. The first fire retardant component may be selected from materials such as borates, polyborates, boric acid, borax, phosphates, or mixtures of these materials. Of these, sodium polyborate is suitable.

The first fire retardant may be dispersed through the fibrous mass either before or after being compressed by any one of several methods. Where the first fire retardant is provided in the form of a powder having a bulk particle size of about 10-30 microns (450-800 mesh), such methods can include blowing the fire retardant powder into sheets of the fibrous mass onto one or both sides of the fibrous mass, or drawing the fire retardant powder through sheets of the fibrous mass with a reduction in pressure on one side thereof, or using a combination of blowing on one side of the sheet of fibrous mass and creating a region of reduced pressure on the other side.

Alternatively, the first fire retardant can be incorporated into the fibrous mass during the production thereof such as by pre-mixing with the natural fiber component, pre-mixing with the thermoplastic component, or by mixing together with the natural fiber and thermoplastic component, prior to or during the formation of the fibrous mass. After the first fire retardant is dispersed in the fibrous mass, the fibrous mass is then heated to a temperature above the softening temperature of the thermoplastic component to allow the thermoplastic material to soften and bind the natural fibers of the mass. The heated mass is compressed to a desired thickness and then optionally cooled for a period of time while in the compressed state so that the mass retains the desired thickness and achieves the desired rigidity.

A second fire retardant is applied as a coating to the exterior surfaces of the fibrous mass. Sodium silicate has been found to be well suited to this purpose. In one embodiment, the second fire retardant is present in a solution of liquid medium as either a solution, a suspension or a mixture. This composition may be applied onto the surfaces of the compressed fibrous mass by techniques such as spraying, brushing, roll coating, curtain coating, froth coating and dipping. In one embodiment, the coating is applied by spraying an aqueous solution including at least 40 wt. % sodium silicate. The coating is then allowed to dry, optionally with heating to drive off the water from the aqueous solution so that the coating sets.

The fire-resistant article of the present invention has a Class A fire rating. Specifically, the fire-resistant article when incorporated into a completed structural panel that includes conventional covering materials, additional adhesives and, optionally, spacer materials in a laminated construction, has a flame spread index (FSI) below 25 or from 0 to 25 and a smoke generation index below 450 or from 0 to 450. More particularly, the fire-resistant article of the present invention in some embodiments has a FSI of 0 to 15 and a smoke generation index of 0 to 100.

Additionally, the fire-resistant article has desirable acoustical properties. The noise reduction coefficient (NRC) as well as the sound transmission class (STC) are useful indicators of the acoustical properties of a given material. The Noise Reduction Coefficient (NRC) is a scalar representation of the amount of sound energy absorbed upon striking a particular surface. In particular, it is the average of four sound absorption coefficients of the particular surface at frequencies of 250 Hz, 500 Hz, 1000 Hz, and 2000 Hz. The Sound Transmission Class (STC) is a widely used integer-number rating of how well a building partition attenuates airborne sound. It is used to rate interior walls, ceilings/floors, doors, windows and exterior wall configurations. The number is derived from sound attenuation values tested at sixteen standard frequencies from 125 Hz to 4000 Hz. These transmission-loss values are then plotted on a sound pressure level graph and the resulting curve is compared to a standard reference contour. These values are fit to the appropriate TL Curve (or Transmission Loss) to determine the STC rating. The fire-resistant article when incorporated into a completed structural panel that includes conventional covering materials, additional adhesives and, optionally, spacer materials in a laminated construction, has a noise reduction coefficient (NRC) ranging from 0.35 to 0.65 and a sound transmission class ranging from 15 to 28.

In one embodiment, for example, a fibrous mass made of a 1300 gsm mat of kenaf and polypropylene was heated and compressed according to the method of the present invention to a thickness of 0.25 inches. Powdered polyborate was added to the compressed mat (15-20 wt. %) followed by the addition of sodium silicate (about 1.2 oz. sodium silicate solids per square foot per side). When incorporated into a structural panel, this compressed and treated mat provided a panel having an STC of 25-26 and a NRC of 0.3-0.4. In another embodiment, a fibrous mat made of 1300 gsm mat of kenaf and polypropylene was heated and compressed according to the method of the present invention to a thickness of 0.275 inches. Powdered polyborate was added to the compressed mat (25-30 wt. %) followed by the addition of sodium silicate (about 1.5-2.5 oz. sodium silicate solids per square foot per side). When incorporated into a structural panel, this compressed and treated mat provided a panel having a STC of 15 and above and a NRC of 0.05 and above.

The present invention further encompasses alternative methods of making the fire-resistant article. One inventive method comprises the steps of (a) providing a fibrous mass comprising a mixture of thermoplastic material and natural fibers, (b) dispersing a first fire retardant component in the fibrous mass, (c) heating the fibrous mass to a temperature above the softening temperature of the thermoplastic material but below the thermal degradation temperature of the natural fibers, (d) compressing the fibrous mass to form a shaped article, (e) applying a coating of a second fire retardant component to the shaped article; and (f) drying the coating.

Another inventive method comprises the steps of (a) providing a fibrous mass comprising a mixture of thermoplastic material and natural fibers, (b) heating the fibrous mass to a temperature above the softening temperature of the thermoplastic material, (c) compressing the fibrous mass to form a shaped article, (d) dispersing a first fire retardant component in the fibrous mass forming the shaped article, (e) applying a coating of a second fire retardant component to the shaped article; and (f) drying the coating.

A further inventive method of the present invention comprises the steps of (a) dispersing a first flame retardant component through a fibrous mass comprising a mixture of thermoplastic material and natural fibers, (b) applying a second flame retardant component to the outer surfaces of the fibrous mass, (c) compressing the mass with heat to both soften the thermoplastic materials to bind the natural fibers and to drive off any water used in the solution or liquid medium from the application of the second flame retardant component.

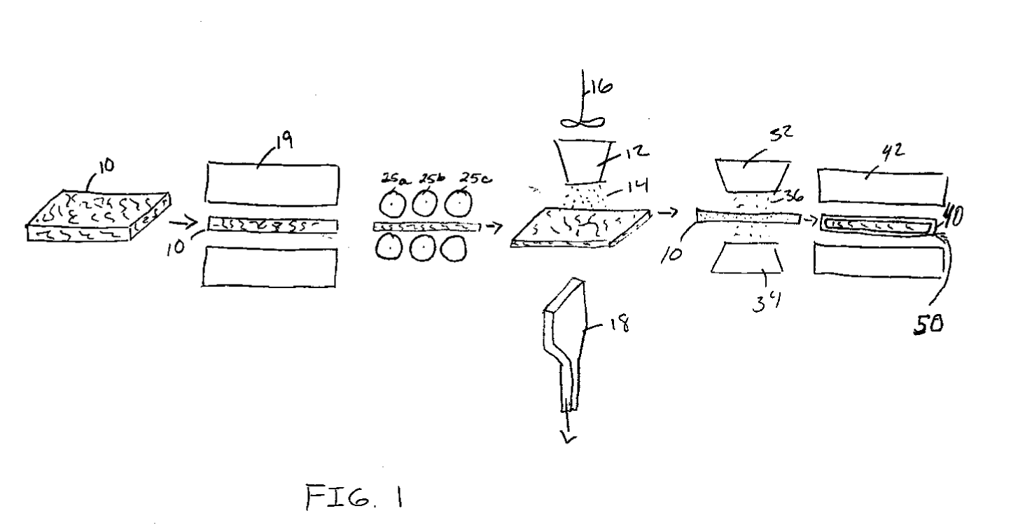

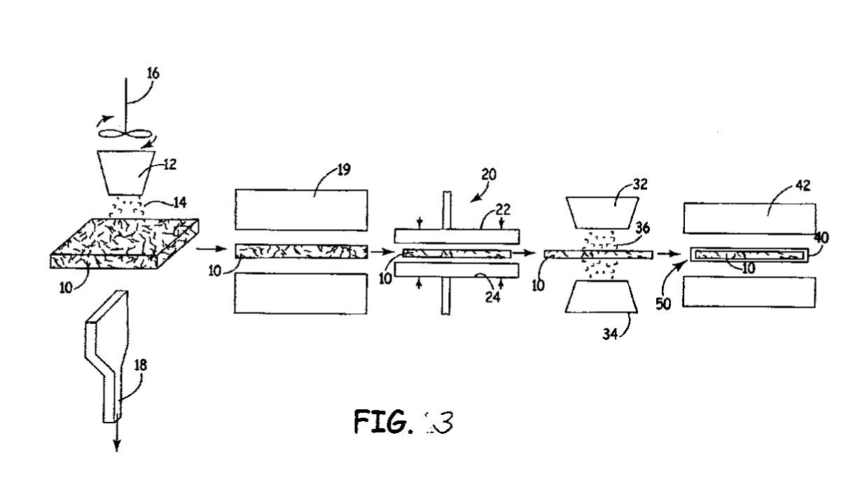

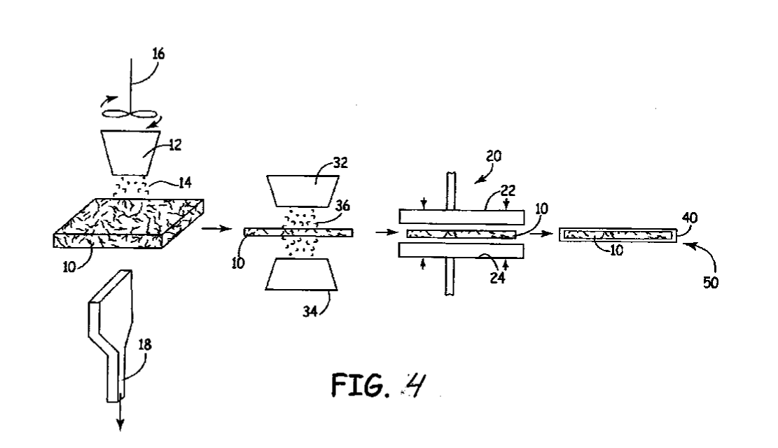

One method of making the fire-resistant article of the present invention is schematically illustrated in FIG. 1. The fibrous mass 10 is passed through an oven 19 where it is heated to a temperature greater than the softening temperature of the thermoplastic component. This allows the thermoplastic material to soften and bind the natural fibers. The heated mass is then passed to a calendaring unit for decreasing the thickness and increasing the density of the fibrous mass 10. As shown in FIG. 1, the calendaring unit includes a set of three nip rollers 25a, 25b and 25c, for decreasing the thickness and increasing the density of the fibrous mass 10. Alternatively, as shown in FIGS. 3 and 4, the fibrous mass 10 can be passed through a press where it is pressed between two press platens 22, 24. In alternative embodiments, any process that provides suitable heat and compression is suitable. The mass is held at the thickness while it is allowed to cool. The fibrous sheet 10 is then conveyed beneath a dispenser 12 that dispenses the first fire retardant 14 to be dispersed within the fibrous mass 10. The dispersal of the first fire retardant 14 into the body of fibrous mass 10 can be facilitated by a blower system 16, and/or a vacuum assist 18 to pull air and fire retardant through the fibrous mass. The choice of whether to use a blower system 16, a vacuum assist 18, or both, may depend on the types of fibers in the fibrous mass, the type of fire retardant used, and the density of the fibrous mass. The fibrous mass 10 is then conveyed to a coating application apparatus, which in the illustrated embodiment is in the form of two spray heads 32, 34, although it will be appreciated that an apparatus with one spray head could be used if the mass 10 is sprayed first on one side and then on the other. The spray heads 32, 34 spray both surfaces of the fibrous mass 10 with a composition 36 containing a second fire retardant material that forms a coating 40 on the exterior surfaces of the fibrous mass 10. The article 50 is the compressed fibrous mass 10 with the first fire retardant dispersed therein and having a coating 40 of the second fire retardant. The coating 40 on the article 50 is allowed to set; this last step can be facilitated by heating the article 50 with a heat source 42 to drive off any liquid medium from the mixture 36, with or without a vacuum assist or forced air.

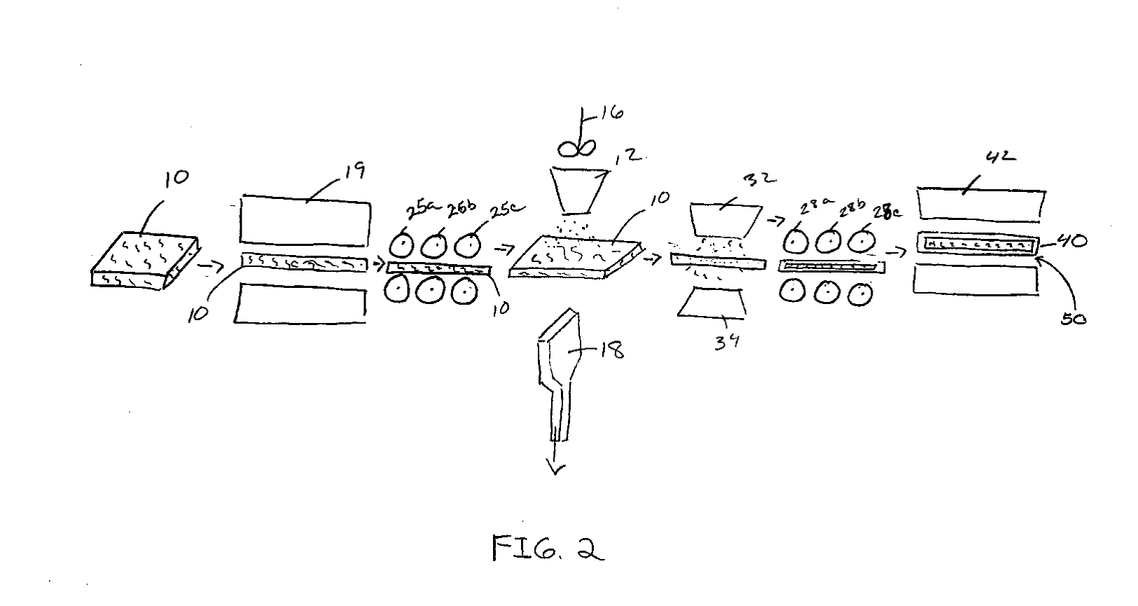

In a variation of the above-described embodiment of the invention, the shaped article is passed through at least one additional set of rollers 28a-c as shown in FIG. 2. During the application of the second fire retardant component in the form of a solution or spray, the liquid from the second fire retardant component can cause the natural fibers on the exterior surface of the shaped article to expand. The expanded natural fibers on the exterior surface of the shaped article may extend away from the surface creating a fuzz-like appearance or texture. The shaped article may be passed through at least one additional set of rollers 28a-c in order to remove any excess liquid from the shaped article and to compress and smooth any extended fibers formed on the exterior surface of the shaped article resulting from the application of the second fire retardant component.

An alternative method of making the fire-resistant article of the present invention is schematically illustrated in FIG. 3. A sheet 10 of a fibrous mass comprising natural fibers and a thermoplastic material is conveyed beneath a dispenser 12 that dispenses the first fire retardant to be dispersed within the fibrous mass. The dispersal of the first fire retardant 14 into the body of fibrous mass 10 can be facilitated by a blower system 16, and/or a vacuum assist 18 to pull air and fire retardant through the fibrous mass. The choice of whether to use a blower system 16, a vacuum assist 18, or both, may depend on the types of fibers in the fibrous mass, the type of fire retardant used, and the density of the fibrous mass. After the first fire retardant is applied, the fibrous mass 10 is passed through an oven 19 where it is heated to a temperature greater than the softening temperature of the thermoplastic component. This allows the thermoplastic material to soften and bind the natural fibers. The heated mass is then passed to a press 20 where it is pressed between two press platens 22, 24, which decreases the thickness and increases the density of the fibrous mass 10. The mass is held at the thickness while it is allowed to cool. The fibrous mass 10 is then conveyed to a coating application apparatus, which in the illustrated embodiment is in the form of two spray heads 32, 34, although it will be appreciated that an apparatus with one spray head could be used if the mass 10 is sprayed first on one side and then on the other. The spray heads 32, 34 spray both surfaces of fibrous mass 10 with a composition 36 containing a second fire retardant material that forms a coating 40 on the exterior surfaces of the fibrous mass 10. The article 50 is the compressed fibrous mass 10 with the first fire retardant dispersed therein and having a coating 40 of the second fire retardant. The coating 40 on the article 50 is allowed to set; this last step can be facilitated by heating the article 50 with a heat source 42 to drive off any liquid medium from the mixture 36, with or without a vacuum assist or forced air.

Another method of making a fire-resistant article of the present invention comprises the steps of (a) providing a fibrous mass comprising a mixture of thermoplastic material and natural fibers, (b) dispersing a first fire retardant component in the fibrous mass, (c) applying a coating of a second fire retardant component to the fibrous mass, (d) heating the fibrous mass, and (e) compressing the fibrous mass to form a shaped article, and allowing the compressed mass to cool. In this method, the heating and compression steps can be conducted separately or simultaneously. The materials that can be used in this second method are the same as those that can be used in the first method. This method is illustrated in FIG. 4, wherein the same elements shown in FIG. 3 are indicated by the same reference numerals. Referring to FIG. 4, a sheet 10 of a fibrous mass comprising natural fibers and a thermoplastic material is conveyed beneath a dispenser 12 that dispenses the first fire retardant 14 to be dispersed within the fibrous mass 10. The dispersal of the fire retardant 14 into the body of fibrous mass 10 can be facilitated by a blower system 16, and/or a vacuum assist 18 to pull air and fire retardant through the fibrous mass. The choice of whether to use a blower system 16, a vacuum assist 18, or both, may depend on the types of fibers in the fibrous mass, the type of fire retardant used, and the density of the fibrous mass. After the first fire retardant is applied, the fibrous mass 10 is then conveyed to a coating application apparatus, which in the illustrated embodiment is in the form of two spray heads 32, 34, although it will be appreciated that an apparatus with one spray head could be used if the mass 10 is sprayed first on one side and then on the other. The spray heads 32, 34 spray both surfaces of the fibrous mass 10 with a mixture 36 containing a second fire retardant material present in a liquid medium that forms a coating 40 around fibrous mass 10. The fibrous mass 10 is then passed to a heating press 20 where it is pressed between two press platens 22, 24 with heat to a temperature greater than the softening temperature of the thermoplastic component. This allows the thermoplastic material to bind the natural fibers, while decreasing the thickness and increasing the density of the fibrous mass 10. This step also can drive off the liquid medium from the coating 40. The resulting article can be used to produce a satisfactory Class A rated fire resistant structure.

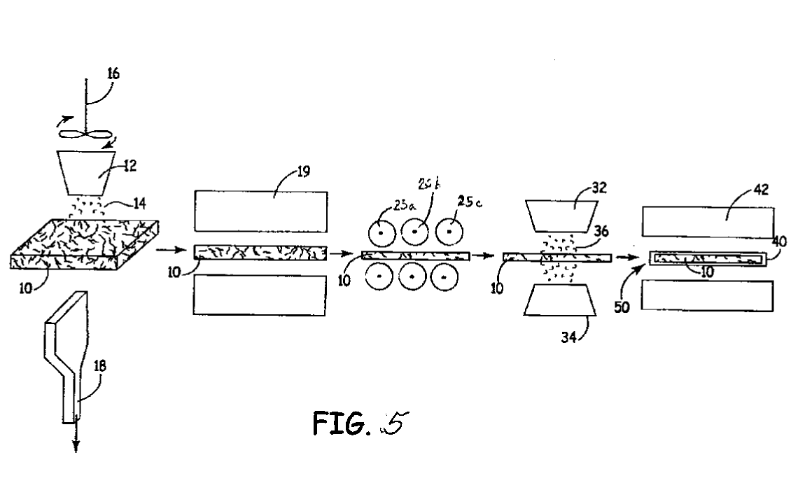

Another method of making the fire-resistant article of the present invention is schematically illustrated in FIG. 5. In this variation of the method illustrated in FIG. 1, a sheet 10 of a fibrous mass comprising natural fibers and a thermoplastic material is conveyed beneath a dispenser 12 that dispenses the first fire retardant to be dispersed within the fibrous mass. The dispersal of the first fire retardant 14 into the body of fibrous mass 10 can be facilitated by a blower system 16, and/or a vacuum assist 18 to pull air and fire retardant through the fibrous mass as described above. After the first fire retardant is applied, the fibrous mass 10 is passed through an oven 19 where it is heated to a temperature greater than the softening temperature of the thermoplastic component. This allows the thermoplastic material to soften and bind the natural fibers. The heated mass is then passed to a set of three nip rollers 25a, 25b and 25c, which decreases the thickness and increases the density of the fibrous mass 10. After passing through the nip rollers 25a, 25b and 25c, the fibrous mass 10 is cooled and then conveyed to a coating application apparatus, which in the illustrated embodiment is in the form of two spray heads 32, 34, although it will be appreciated that an apparatus with other methods of applying the coating onto the exterior surfaces of the fibrous mass would be suitable. The spray heads 32, 34 spray both surfaces of fibrous mass 10 with a composition 36 containing a second fire retardant material that forms a coating 40 on the exterior surfaces of the fibrous mass 10. The coating 40 on the article 50 is allowed to set; this last step can be facilitated by heating the article 50 with a heat source 42 to drive off any water from the composition 36.

The fire-resistant and/or acoustical absorbing article disclosed herein avoids the use of fiberglass and added formaldehyde-containing materials. The article so made can be used in the manufacture of furniture, office partition panels, ceiling tiles, bulletin boards, and other articles and structures useful in office, school, and industrial environments that require Glass A fire-resistant structure and/or noise control. Articles made according to the present method also have satisfactory structural properties. For example, articles having a density in a range of 17-24 pcf were found to have a modulus of elasticity (MOE) of more than 300,000 psi across the width and more than 270,000 psi across the length for multiple samples tested in a three point bend test modeled after ASTM D 1037-96a (the testing deviated from the ASTM methods because the samples were not conditioned, the moisture content was not measured and the sample size span was greater than the ASTM standard). In addition, the various samples were found to have a modulus of rupture (MOR) of more than 1900 psi across the width and more than 1800 across the length of the samples.

### EXAMPLE 1

A fibrous mass is provided comprising about 20% by weight of polypropylene fibers and about 80% by weight of a natural fiber component, the component containing 50% by weight of kenaf fiber and 50% by weight of industrial hemp fiber. The mass is heated to a temperature of about 375°-380° F. for about 10-15 minutes in a conventional oven. The mass is compressed to a desired thickness and allowed to cool. Next, sodium polyborate powder is blown through the mass. Then, the compressed mass is sprayed on all surfaces with a 40% by weight aqueous solution of sodium silicate, at about 1-2 oz. solution per square foot of surface area. The mass is then heated to a temperature of about 375° for about 1-2 minutes to drive off the water and allow the sodium silicate coating to set. Structures made with the article can be useful in furniture, office partitions, ceiling tiles, and the like.

### EXAMPLE 2

A fibrous mass is provided comprising about 20% by weight of polypropylene fibers and about 80% by weight of a natural fiber component, the component containing 50% by weight of kenaf fiber and 50% by weight of industrial hemp fiber. Sodium polyborate powder is blown through the mass. The mass is heated to a temperature of about 375°-380° F. for about 10-15 minutes in a conventional oven. The mass is compressed to a desired thickness and allowed to cool. The compressed mass is sprayed on all surfaces with a 40% by weight aqueous solution of sodium silicate, at about 1-2 oz. solution per square foot of surface area. The mass is then heated to a temperature of about 375° for about 1-2 minutes to drive off the water and allow the sodium silicate coating to set. The resulting article can be used in the manufacture of a structure having a flame spread index of less than 25 and a smoke generation index of less than 450, which meets the requirement for a Class A rated fire resistant article. Structures made with the article can be useful in furniture, office partitions, ceiling tiles, and the like.

Modifications and variations of the inventive article and methods are possible in light of the above teachings. It is therefore to be understood that within the scope of the appended claims, the invention may be practiced otherwise than as specifically described herein.

We claim:

1. A method of making a fire-resistant article, said method comprising the steps of:
(a) providing a fibrous mass comprising a mixture of thermoplastic material and bast fibers;
(b) heating the fibrous mass to a temperature above the softening temperature of the thermoplastic material but below a thermal degradation temperature of the bast fibers;
(c) compressing the mass to form a shaped article;
(d) dispersing a first fire retardant component in the fibrous mass; and
(e) applying a coating of a second fire retardant component to the shaped article.

2. The method according to claim 1, further comprising at least one additional step of compressing the shaped article after applying the coating of the second fire retardant component to the shaped article.

3. The method of claim 1 wherein the fibrous mass comprises about 1-50 wt. % thermoplastic material and about 50-99 wt. % natural fiber.

4. The method of claim 1 wherein the bast fibers are kenaf, jute, industrial hemp, sisal, flax, or mixtures thereof.

5. The method of claim 4 wherein the natural fibers comprise kenaf.

6. The method of claim 1 wherein the thermoplastic material is fibers, bi-component fibers, powder, or pellets.

7. The method of claim 1 wherein the thermoplastic material comprises polypropylene, polyethylene, polyesters, nylon, copolymers, or mixtures thereof.

8. The method of claim 7 wherein the thermoplastic material is polypropylene.

9. The method of claim 1 wherein the first fire retardant comprises borates, polyborates, boric acid, borax, phosphates, or mixtures thereof.

10. The method of claim 9 wherein the first fire retardant component comprises sodium polyborate.

11. The method of claim 1 wherein the second fire retardant component is applied as a liquid composition.

12. The method of claim 1 comprising the further step of heating the article after the application of the second fire retardant component to set the second fire retardant component on the article.

13. The method of claim 1 wherein the second fire retardant component comprises sodium silicate.

14. The method of claim 1, wherein the compressing the mass includes calendaring the mass.

15. The method according to claim 1, wherein the fire resistant article comprises a fibrous mass having a fiber component and about 540 wt. % of a first fire retardant component mixed therein, said fiber component comprising about 1-50 wt. % thermoplastic material and about 50-99 wt. % bast fiber, wherein the fibrous mass has a coating of a second fire retardant component on exterior surfaces of the fibrous mass.

16. The method according to claim 1, wherein the fire resistant article has a Class A fire rating.

17. The method according to claim 1, wherein the fire resistant article has a noise reduction coefficient ranging from 0.35 to 0.65.

18. The method according to claim 1, wherein the fire-resistant article has a sound transmission class ranging from 15 to 28.

19. A fire-resistant article comprising: a fibrous mass having a fiber component and about 540 wt. % of a first fire retardant component mixed therein, said fiber component comprising about 1-50 wt. % thermoplastic material and about 50-99 wt. % bast fiber, the fibrous mass having a coating of a second fire retardant component on exterior surfaces of the fibrous mass; wherein the fire-resistant article has acoustical absorbing properties.

20. The fire-resistant article according to claim 19, wherein the article has a sound transmission class ranging from 15 to 28.

21. The fire-resistant article according to claim 19, wherein the article has a noise reduction coefficient ranging from 0.35 to 0.65.

22. A fire-resistant article manufactured according to the method of claim 1.

23. The fire-resistant article of claim 21, wherein the fire-resistant article has acoustical properties.
